(19) United States
(12) Patent Application Publication
(10) Pub. No.: US 2026/0331071 A1
(43) Pub. Date: Oct. 22, 2026

(54) System and method for auto recovery of LCD display in smart thermostats

(71) Applicant: Lennox Industries Inc., Richardson, TX (US)

(72) Inventors: Aravind Sridharan, Kelambakkam (IN); Anantha Narayanan Ramachandran, Chennai (IN)

(21) Appl. No.: 19/181,708

(22) Filed: Apr. 17, 2025

(51) Int. Cl. G09G 3/36; F24F 11/52

(52) U.S. Cl. CPC G09G 3/36; F24F 11/52; G09G 2330/026; G09G 2330/027

(57) ABSTRACT

A thermostat that includes a display screen and a processor connected to the display screen. The display screen is configured to display information received from the processor related to the operation of a heating or cooling system. The processor monitors on a connector normally associated with a tear enable signal, a periodic signal received from the display screen. The processor determines if the periodic signal has been received during a predetermined period of time, and if the signal is not received during that predetermined period of time, the processor performs a reset action to reset the display screen.

### TECHNICAL FIELD

This disclosure relates generally to heating and cooling systems and specifically to thermostats which control the heating and cooling systems. In particular, the disclosure relates to a system and method for auto recovery of LCD displays in smart thermostats.

### BACKGROUND

Heating, ventilation, and air conditioning (HVAC) systems may include thermostats that allow users to control them. Thermostats use sensors to measure one or more characteristics of the environment heated or cooled by the HVAC system and activate or deactivate components of the HVAC system based on those measurements. Thermostats may additionally provide information to the users via a display, such as the measurements and status information for the HVAC, allowing a user to adjust the heating or cooling settings of the HVAC system.

### SUMMARY

Thermostats for controlling HVAC systems may come in many forms. One increasingly popular form includes a processor and a connected digital display screen. The display screen may display information on temperature, system status, and other useful information. When the display screen and processor are functioning normally, a user may make informed decisions about adjusting the temperature and other settings of the HVAC system. However, problems may occur, causing the display to no longer display the information received from the processor. When this happens, a user is no longer able to control the HVAC system and may need a technician to come and service the thermostat. This may also result in damage to the HVAC system or discomfort to the user while waiting for a technician to repair the thermostat.

A thermostat's display, such as a liquid crystal display (LCD), may display a blank screen even though the thermostat's processor is still functioning. This may occur, for example, due to a loss of synchronization caused by electrostatic discharge (ESD) from a user in the proximity of the thermostat or internal events such as power supply interruptions. In many of these cases, the display may easily be reset by the processor sending reset signals and/or interrupting the power supplied to the display. However, there is currently no method for the processor to determine that the display is displaying a blank screen in order for the processor to attempt to perform corrective actions automatically.

This disclosure provides technical solutions to the problems of the previous technology, including those described above. In one or more embodiments, an HVAC system is provided that includes a thermostat, such as a so-called smart thermostat, which is capable of being programmed to provide different levels of heating and cooling depending on a user’s preferences and time of day. The thermostat includes both a processor and a digital display, which, when functioning, displays system information, sensor information, and other helpful information. The digital display also sends a periodic signal to the processor. When that signal is absent for a predetermined amount of time, the processor automatically performs a reset action to attempt to reset the display.

In one or more embodiments, the processor uses a connection or pin typically configured to receive a tear enable signal to receive the periodic signal from the display. The thermostat displays generally do not need to use the tear enable signal, and the corresponding connection is generally unused in previous thermostats and HVAC technology. By using this connection to receive the periodic signal, the processor may use an existing connection to receive this signal, and no new additional connections, such as new pins, are needed for the processor to determine if the display is functioning. By monitoring this periodic signal using the existing tear enable signal, the processor may perform one or more steps to reset the display, often eliminating the need for a user or technician to repair the thermostat.

In an embodiment, a thermostat is provided, which includes a display screen and a processor operably coupled to the display screen. The display screen is configured to display information received from the processor, which is associated with operating a heating or cooling system. The processor monitors a periodic signal received from the display screen using a connector of the processor associated with a tear enable signal. The processor determines if the periodic signal has been received during the first predetermined period of time and performs a reset action to reset the display screen when the periodic signal is not received in the first predetermined period of time.

The reset action may include multiple steps including a first step that comprises electronically sending a reset display signal to the display screen. The processor may then wait a second predetermined period of time to determine if the periodic signal has resumed, and if not, the processor may then perform an action to reset both the processor and the display screen. This may include causing a power sequencer that provides power to the processor and the display screen to reset the power to both the processor and the display screen. Alternatively, or additionally, the processor may perform a kernel panic and automatically reboot both itself and the display screen.

If, after performing the reset actions, the periodic signal is still not received during another predetermined period of time, the processor may then electronically send an electronic signal to an external device, indicating that repair may be needed. In each step, the processor may store data related to its functioning, the periodic signal, and the display screen in a log. A technician or the external system may use this log to determine a proper repair. This log may also indicate if a loopback signal is present; when the loopback signal is not present, it indicates that the display screen is not properly connected to the processor.

### BRIEF DESCRIPTION OF THE DRAWINGS

For a more complete understanding of the present disclosure, reference is now made to the following description, taken in conjunction with the accompanying drawings in which:

FIG. 1 is a diagram of an example system that includes a thermostat in accordance with one or more embodiments;

FIG. 2 is a diagram of the example processor of FIG. 1 in accordance with one or more embodiments;

FIG. 3 is a flowchart of an example method of operating the thermostat of FIGS. 1 and 2 to determine if a reset action should be performed in accordance with one or more embodiments; and

FIG. 4 is a flowchart of an example method of performing the reset action of the thermostat of FIGS. 1 and 2 in accordance with one or more embodiments.

### DETAILED DESCRIPTION

Various embodiments will now be described more fully with reference to the accompanying drawings. The disclosure may, however, be embodied in many different forms and should not be construed as limited to the embodiments set forth herein.

Heating, Ventilation, and Air Conditioning (HVAC) systems are configured to provide cooling and heating to target spaces. An HVAC system operates in a heating mode to provide heating to a target space and in a cooling mode to provide cooling to the target space. HVAC systems are often controlled, at least in part, by a thermostat that monitors the ambient temperature in the target space and determines, based on temperature set points or other inputs from a user, when to activate heating or cooling devices that are part of the HVAC system.

In one or more embodiments, the HVAC system uses a digital or smart thermostat. Smart and other types of digital thermostats typically include a display screen that may use a liquid crystal display (LCD) or other similar technology. The display screen is used to display information such as, but not limited to, the current ambient temperature, one or more temperature set points, the current system status, and any other information that is useful for a user or a technician to be able to understand the current operation of the HVAC system. The display screen may also be touch-sensitive, allowing the user to press icons on the display screen to manipulate such things as the temperature set points.

However, the display screens and/or the processors that control them in a thermostat are sensitive to static electricity, power fluctuations, and/or problems with the screens or processors. One or more embodiments of the present disclosure are directed towards a thermostat that, either alone or as part of an HVAC system, includes a method to determine when a problem has occurred with the display screen and take appropriate actions to reset the display screen and/or processor as needed. In the past, when a display screen of a thermostat malfunctioned and stopped displaying current or any information, the only recourse that a user would have was to force a restart to the entire HVAC system and/or have a technician come and perform costly repairs, even when only minor actions such as resetting the display screen or processor would have been needed to restore the display screen.

The disclosed system provides a solution to these and other technical problems of conventional HVAC systems and their thermostats. In some embodiments, the disclosed system uses a tear enable pin of the display to receive a periodic signal indicating that the display is functioning. When this signal is no longer present, the disclosed system performs one or more actions to attempt to fix the display screen automatically. By performing these steps, often no user or technician intervention will be needed to restore the functioning of the display screen of a smart thermostat. This makes the smart thermostat of the HVAC system more reliable, with less operation cost due to the reduction of service calls for minor display problems.

### HVAC System, Overview

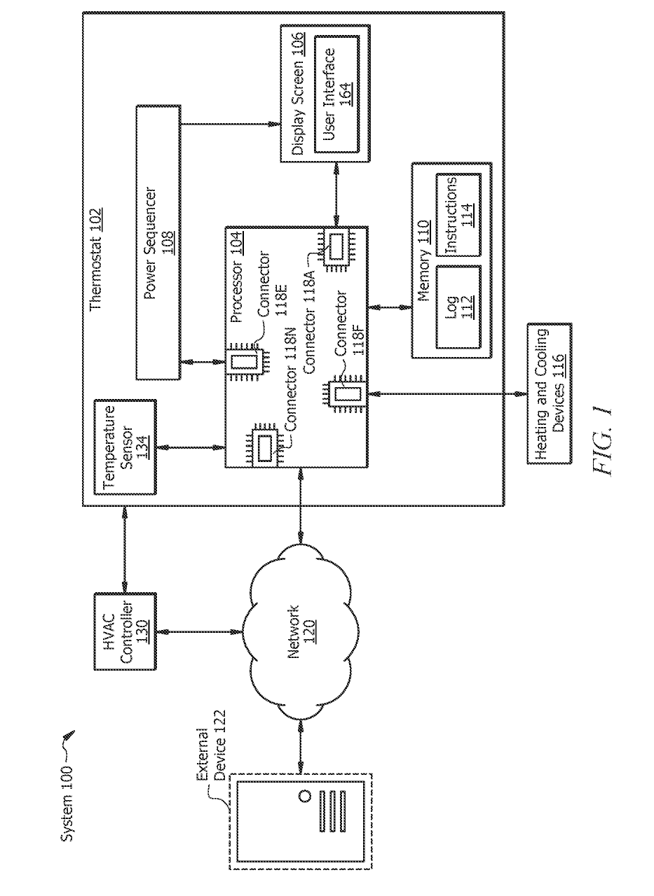

FIG. 1 illustrates an example HVAC system 100 according to an embodiment of the present disclosure. The HVAC system 100 conditions air for delivery to a conditioned space, e.g., all or a portion of a room, a house, an office building, or a warehouse. The HVAC system 100 may be configured as shown in FIG. 1 or any other suitable configuration. For example, the HVAC system 100 may include additional components or omit one or more components shown in FIG. 1. In one or more embodiments, the HVAC system 100 includes a thermostat 102, heating and cooling devices 116 and may be connected through a network 120 to one or more external devices 122 and/or an optional HVAC controller 130. The HVAC system 100 may include other components, such as controllers and sensors that are not shown but interact with the thermostat 102 to control the heating and cooling devices 116.

### System Components

### External Device

The external devices 122 may include any number of devices that interact with the thermostat 102 and/or the HVAC system 100. The external device 122 may be a user device, a technician's device, or a manufacturer’s system that monitors the functioning of the HVAC system 100. The external device 122 may be a controller that is part of an environmental control system and/or may take the place of the HVAC controller 130. The external device 122 may take any form and may be any device that interacts through a network 120 with the thermostat and heating and cooling devices 116.

In one or more embodiments, the external devices 122 may include but is not limited to, computers, laptops, mobile devices (e.g., smartphones or tablets), servers, clients, or any other suitable type of devices that may be used for accessing or supporting HVAC system 100 and/or thermostat 102. While only one external device 122 is shown, a plurality of external devices, e.g., 122, may be present in one or more embodiments. The external device 122 may include devices such as, but not limited to, processors, displays, memory, storage, network components, and other components that are common to computational devices.

### Network

The network 120 may be any suitable type of wireless and/or wired network including, but not limited to, all or a portion of the Internet, an intranet, a private network, a public network, a peer-to-peer network, the public switched telephone network, a cellular network, a local area network (LAN), a metropolitan area network (MAN), a wide area network (WAN), and a satellite network. The network 120 may be configured to support any suitable type of communication protocol as would be appreciated by one of ordinary skill in the art.

The network 120 may connect the thermostat 102, heating and cooling devices 116, and external device 122 with each other. The network 120 may connect other components, such as an optional HVAC controller 130 and/or other components that are not shown used to control or operate the HVAC system 100. Network 120 may connect the external device 122 to other components of the HVAC system 100 through the Internet or other large networks. While shown as a single network 120, the network 120 may comprise a plurality of components of any suitable networking equipment, including but not limited to routers and switches, that allow at least the external device 122 to communicate with the thermostat 102 and/or heating and cooling devices 116. Network 120 is not limited to the configuration shown in FIG. 1, which is shown in this form for simplicity and explanatory purposes.

### Heating and Cooling Devices

The heating and cooling devices 116 are devices for heating and cooling a target environment. The heating and cooling devices 116 may take any form and, in one or more embodiments, may take the form of a heat pump. Alternatively, the heating and cooling devices 116 may comprise separate heating and cooling components. The heating and cooling devices 116 may include multiple components used for heating and/or cooling an environment, such as indoor and outdoor units, along with coils, blowers, air ducts, and other components used for heating or cooling a target environment.

The heating and cooling devices 116 receive signals from the thermostat 102 in one or more embodiments. For example, heating and cooling devices 116 may receive signals from processor 104, which will be described in more detail below. The processor 104 may include a plurality of connectors 118A-118N, which may provide a signal to the heating and cooling devices 116. For example, one connector 118F of a processor 104 in the thermostat 102 may send and receive signals from the heating and cooling devices 116. These signals may include instructions to activate heating or cooling, power for operating the heating and cooling devices 116, and/or feedback from the heating and cooling devices 116. The signals between the processor 104 to and from the heating and cooling device 116 may take the form of digital signals, direct current pulses, and/or A/C power for operating the heating and cooling devices 116.

### Controller

The HVAC system 100 includes an optional HVAC controller 130 in one or more embodiments. The optional HVAC controller 130 may be communicatively coupled to both the thermostat 102 and heating and cooling device 116 through the network 120. Alternatively, the optional HVAC controller 130 may communicate via wired and/or wireless connections to a connector, e.g., 118N of the processor 104. The optional HVAC controller 130 may include processors, memory, and other components that are configured to control the operations of the heating and cooling devices 116. The optional HVAC controller 130 may receive information from the thermostat 102 and/or sensors in the environment to be heated or cool. Based on this information, the HVAC controller 130 controls the operation of the heating and cooling devices 116. Alternatively, in one or more embodiments, the HVAC controller 130 may be a part of the heating and cooling devices 116, or it may be part of the thermostat 102, for example, in a non-limiting example, the processor 104.

### Thermostat

The thermostat 102 may generally be an electronic device with which users may interact, input data, view temperature, and other data related to the HVAC system 100. The thermostat 102 may be positioned within the conditioned space, e.g., a room or building serviced by the HVAC system 100. In some embodiments, the thermostat 102 may be separate from the HVAC controller 130 and may be in signal communication with the HVAC controller 130 via wired and/or wireless communication or network 120. In some other embodiments, the HVAC controller 130 may be integrated into the thermostat 102 and in signal communication with the components of the HVAC system 100. The thermostat 102 is configured to allow a user to input a desired temperature or baseline setpoint temperature for the conditioned space. The thermostat 102 may display the current temperature within the conditioned space that it receives from either the HVAC controller 130 and/or temperature sensor 134.

In one or more embodiments, the thermostat 102 may include at least one processor 104 connected via connectors 118A-118N to various components of the thermostat 102. The thermostat 102 may include a temperature sensor 134, a power sequencer 108, a memory 110, and a display screen 106. The thermostat 102 may include more or fewer components than shown in FIG. 1. For example, the thermostat may include a separate user interface, e.g., a user interface 164, for allowing a user to interact with the thermostat 102. In one or more embodiments, the display screen 106 includes the user interface 164 in the form of a haptic interface or other type of user interface and forms part of a touch screen.

In one or more embodiments, the thermostat 102 includes a temperature sensor 134 or other sensors. The temperature sensors 134 may include ambient sensors for detecting the temperature in the environment where the thermostat 102 is positioned. They may include other sensors such as, but not limited to, humidity and/or other data needed to control the HVAC system 100. The temperature sensor 134 may comprise a signal sensor or a plurality of temperature sensors, e.g., 134, that may be present in the thermostat 102 or throughout the HVAC system 100. The temperature sensors 134 may communicate with the processor 104 through one of the connectors 118A-118N and/or the network 120.

In one or more embodiments, the thermostat 102 includes a power sequencer 108. The power sequencer 108 provides power to the processor 104, display screen 106, and other components of the thermostat 102 and controls and/or causes the processor, display screen 106, and other components of the thermostat 102 to turn on and off. The power sequencer 108 may receive external alternating current (AC) power and provide the appropriate power in the form of either direct current (DC) or AC to the components of the thermostat 102 and/or the heating and cooling devices 116. The power sequencer 108 may include one or more separate processors or may be strictly a mechanical device controlled by signals received from the processor 104.

In one or more embodiments, the thermostat 102 includes a display screen 106 for displaying information related to the operation and/or status of the HVAC system 100. For example, the processor 104 may communicate through connector 118A with the display screen 106 to show operational, diagnostic, and/or status messages and provide a visual interface that allows at least one of an installer, a user, a support entity, and a service provider to perform actions with respect to the HVAC system 100. For example, the processor 104 may communicate with the display screen 106 to display the current ambient temperature measured by temperature sensor 134. It may also display a temperature set point that a user using the user interface 164 programmed the thermostat and/or HVAC system 100 to activate the heating and cooling devices 116. For example, in a non-limiting example, the display screen 106 may display the current ambient temperature as 72°F (e.g., 72 degrees Fahrenheit) or 22.2°C (e.g., 22.2 degrees Celsius), the set point for activating cooling at 70°F or 21.1°C, and a cooling system of the heating and cooling devices 116 is currently operating. The display screen 106 may include more or less information, including time, system status, fan status, humidity, maintenance schedules, and/or any other information that is determined to be useful to a user or technician.

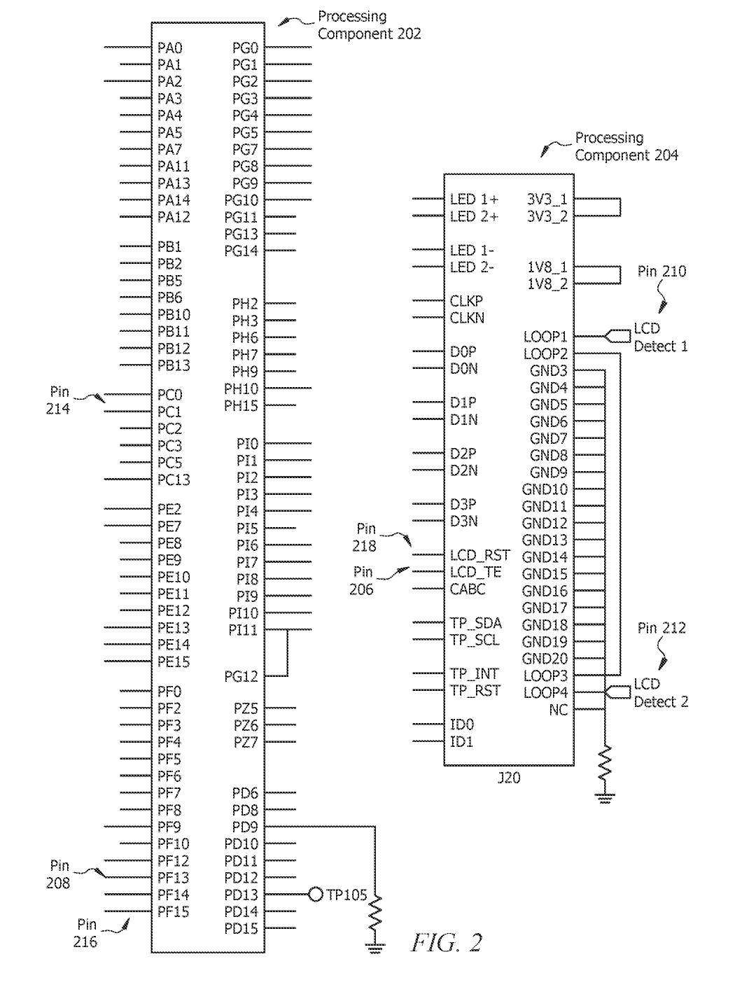

In one or more embodiments, the display screen 106 is a liquid crystal display (LCD). However, the display screen 106 may be any type of display screen such as, but not limited to, light emitting diode (LED), organic light emitting diode (OLED), or any other type of display that is useful for displaying operating and other HVAC system 100 related information. As shown in FIG. 2, the display screen 106 may include a processing component 204 that includes multiple connectors/pins that are in signal communication with the connectors 118A-118N of processor 104. Both the display screen 106 and the processor 104 may include more connectors than shown in FIG. 1 as well as in FIG. 2 described below.

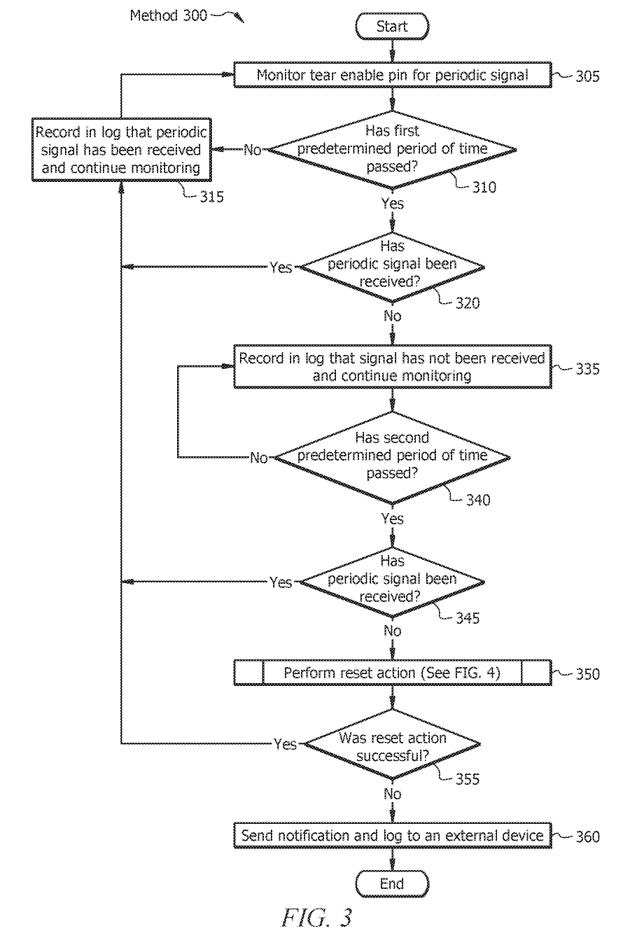

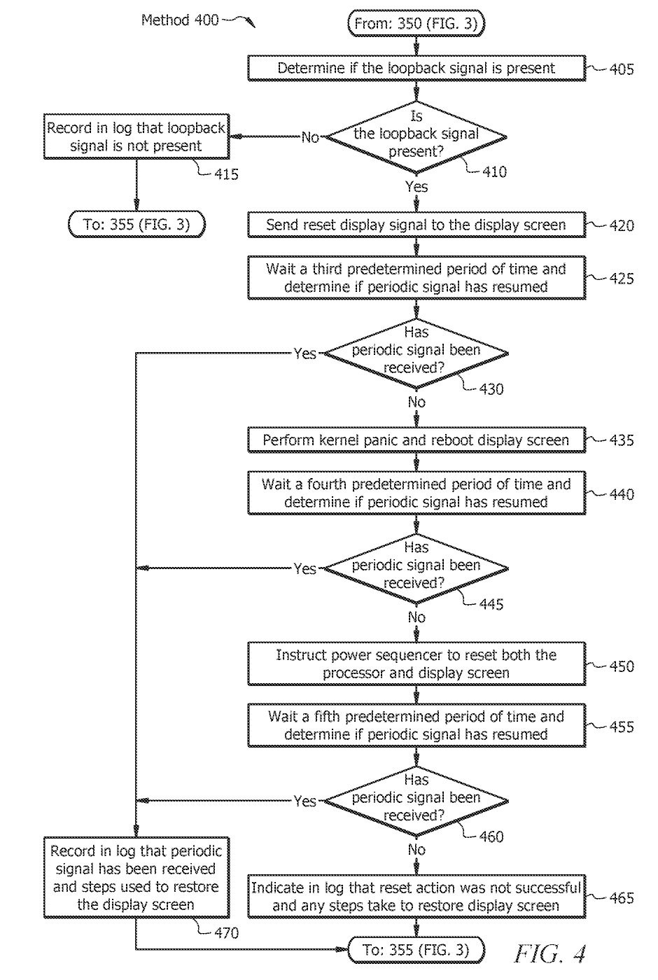

In one or more embodiments, the thermostat 102 includes memory 110 that is operatively connected to the processor 104. The memory 110 may be a non-transitory computer-readable medium. The memory 110 may include one or more disks, tape drives, or solid-state drives and may be used as to store such things as logs 112 and instructions 114 for operating the processor 104 and other components of the HVAC system 100. The memory 110 may be volatile or non-volatile. It may comprise read-only memory (ROM), random-access memory (RAM), ternary content-addressable memory (TCAM), dynamic random-access memory (DRAM), and static random-access memory (SRAM). The memory 110 is operable to store any suitable set of instructions 114, logic, rules, and/or code for executing the functions described in this disclosure. For example, the memory 110 may store and retrieve information corresponding to software instructions 114, logs 112, and/or any other data, instructions, and operating parameters needed for operating the HVAC system 100. In one or more embodiments, the instructions 114 stored in the memory 110 are used by a processor 104 to control the display screen 106, power sequencer 108, and heating and cooling devices 116. The instructions 114 may include one or more operations such as, but not limited to, those described below with regards to FIGS. 3 and 4.

The processor 104 may comprise one or more processors or may comprise a single processor. The processor may include processing components such as processing component 202 described below with regards to FIG. 2 and/or may take a different form and include additional processors and connectors than those shown and described in FIG. 2. The processor 104 may take the form of any electronic circuitry including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs) that communicatively couples to memory 110 and controls the operation of HVAC system 100. The processor 104 may be a programmable logic device, a microcontroller, a microprocessor, or any suitable combination of the preceding. The processor 104 is communicatively coupled to and in signal communication with the memory 110.

The one or more processors 104 are configured to process data and may be implemented in hardware or software. For example, the processor 104 may be 8-bit, 16-bit, 32-bit, 64-bit, or of any other suitable architecture. The processor 104 may include an arithmetic logic unit (ALU) for performing arithmetic and logic operations, processor registers that supply operands to the ALU and store the results of ALU operations, and a control unit that fetches instructions from memory 110 and executes them by directing the coordinated operations of the ALU, registers, and other components. The processor 104 may include other hardware and software that operates to process information, controls the display screen 106, the heating and cooling devices 116, and/or any other component of the HVAC system 100, and perform any of the functions described herein. The processor 104 may be configured to perform one or more operations of the thermostat 102, described in FIG. 1, and one or more operations of the methods 300 and 400, described in FIGS. 3 and 4.

The processor 104 is configured to control both the display screen 106 and the heating and cooling devices 116. The processor 104 using temperature data obtained from the temperature sensor 134 and/or other data causes the heating and cooling devices 116 to either provide heat or cooling based on temperature set points obtained from the user interface 164 or from other sources such as the external device 122. In one or more embodiments, the processor 104 may work with the HVAC controller 130 to control the heating and cooling devices, or the processor 104 may control the heating and cooling devices 116 without or instead of the HVAC controller 130.

In one or more embodiments, the processor 104 is configured to determine when the display screen 106 is not functioning correctly, as will be described in more detail with regard to methods 300 and 400 shown in FIGS. 3 and 4. In one or more embodiments, the display screen 106 may periodically send a signal such as a heartbeat signal from a display screen 106 connector such as pin 206 which will be described in more detail below with regards to FIG. 2. This periodic signal in one or more embodiments is sent from a pin, e.g., 206 of the processing component 204, which is part of the display screen 106. The pin, e.g., 206, used for the periodic signal, is normally used for a tear enable signal (TE) and received by a pin, e.g., 208 of the processing component 202 of the processor 104 that normally receives the TE signal. The TE signal is normally a feedback signal from the LCD to the processor 104 to avoid synchronization errors between reading and writing data to the same location. However, in many applications, such as the thermostat 102, where the display screen 106 does not need to be updated as frequently as applications that display high-resolution video, the TE signal is generally not used, at least for synchronization.

In one or more embodiments, this TE signal is repurposed to provide a periodic or heartbeat signal to processor 104. As will be described in more detail below with regards to FIG. 2 and with regards to method 300 of FIG. 3, when the periodic signal is not received, the processor 104 waits at least a first period time to determine that the periodic signal is not present. This predetermined amount of time may be any amount of time, for example, thirty seconds, a minute, or another time period that is sufficient to indicate that the display screen 106 is no longer functioning but not so short that the processor 104 is constantly performing reset actions even when the display screen 106 is functioning properly.

In one or more embodiments, when the processor 104 does not receive the periodic signal after the first predetermined period of time, the lack of the signal is recorded in log 112, as well as any other pertinent information. The processor 104 then waits a second period of time to ensure that the periodic signal has not returned. The second period of time may be any period of time, such as, but not limited to, an additional thirty seconds, ninety seconds, or any other time period. If the periodic signal is not received, then the processor 104 performs operations as will be described in more detail below with respect to the method 400 of FIG. 4 to restore the display screen 106.

In one or more embodiments, the processor 104, before performing any reset operation, may monitor for a loopback signal or other signals that indicate that the display screen 106 is still properly connected to the processor 104. This avoids damaging either the processor 104 or display screen 106 by needlessly sending electrical signals when the display screen 106 is physically disconnected. This may also avoid inadvertently injuring a technician or user. If processor 104 determines that a loopback signal is not present during a predetermined period of time, the processor logs this issue in logs 112, stored in memory 110. However, if the loopback signal is present, then the processor 104 performs reset actions such as but not limited to sending a reset display signal to the display screen 106, performing a kernel panic, rebooting the display screen 106, and instructing the power sequencer 108 to reset both the processor 104 and display screen 106.

While performing the reset actions or immediately after, in one or more embodiments, the processor 104 will log which signals were not received and what steps have been taken to restore the display screen 106. Additionally, when none of the reset actions are successful or the loopback signal is not present, the processor 104 through the network 120 notifies the external device 122 that repairs are needed. A technician or other pertinent party may then use the information stored in the log 112 to make appropriate repairs. If the reset action is successful, the processor 104 logs 112 the steps that were taken, and the processor 104 continues to monitor the periodic signal received from the display screen 106 to determine whether the display screen 106 is continuing to function properly.

### Example Processor and Display Pins

FIG. 2 illustrates details of a processing component 202 associated with the processor 104 and a processing component 204 of the display screen 106 in accordance with an embodiment of the present disclosure. While described as being part of processor 104 and display screen 106 of FIG. 1, processing components 202 and 204 of FIG. 2 may be part of any other components and are not limited to those described in FIG. 1 as being a part of thermostat 102. For example, in a non-limiting example, processing component 202 may be part of an HVAC controller 130. The processing components 202 and 204 may take the form of microprocessors, integrated circuits, or any other suitable forms and are not limited to those shown in FIG. 2.

In one or more embodiments, processing component 202 and processing component 204 may include a plethora of pins or connectors, as shown in FIG. 2. While each of these pins or connectors has a particular use in operating the thermostat 102 and/or HVAC system 100, only those pins or connectors that are used in performing one or more of the operations described below with regards to method 300 and method 400 of FIGS. 3 and 4 are described herein. While pins 206-212 are labeled in FIG. 2 and described below, other unlabeled pins may serve various purposes and be required for operating the processor 104, display screen 106, and/or HVAC system 100 in general. Processing components 202 and 204 may include more or fewer pins than are shown in FIG. 2, and the specific pins shown are merely examples and for explanatory purposes. The disclosure is not limited to the processing components 202 and 204, as shown in FIG. 2, and both processor 104 and display screen 106 may comprise other processing components and/or take other forms than those shown in FIG. 2 without departing from the disclosure.

In one or more embodiments, processing component 204 includes a pin 206, which is normally used to provide tear signals to processing component 202. However, in one or more embodiments, a periodic or heartbeat signal is produced by processing component 204 and sent from pin 206 to processing component 202. Processing component 202 may receive the periodic signal that takes place or accompanies the tear enable signal on pin 208. As described in more detail below with regards to FIGS. 3 and 4, when the periodic signal is not received by processing component 202 on pin 208, the processing component 202, as well as other components of the HVAC system 100, perform one or more operations to attempt to restore the operation of the display screen 106.

In one or more embodiments, when the processor 104 determines that the periodic signal has not been received in both the first and second predetermined amounts of time, operations are performed to restore the operation of the display screen. The first and second periods of time may be any amount of time, with the first predetermined amount of time being selected as being sufficiently long enough to avoid unnecessary reset operations or logging but not so long that a user would become unnecessarily concerned that the thermostat 102 and/or HVAC system 100 are no longer function. Similarly, the second period of time is sufficient to indicate that active actions are needed to restore the operation of the display screen 106. In one or more embodiments, both the first predetermined amount of time and the second predetermined amount of time are the same amounts of time. Alternatively, they may be different amounts of time, and both may be several seconds, thirty seconds, a minute, multiple minutes, or any other amount of time without departing from the disclosure.

Once a determination is made that the periodic signal has not been received on pin 208 after both the first and second period of time or any other predetermined periods of time, the processor 104 in one or more embodiments may perform an operation to determine if the display screen 106 is properly and/or still connected to the processor 104. In one or more embodiments, this is done by determining if a loopback signal is present. A signal is sent from pin 212 of processing component 204 to pin 214 of processing component 202. Processing component 202 then returns the signal to pin 210 of processing component 204. If the loopback signal is not received by pin 214 during a predetermined period of time, processor 104 then determines that the display screen 106 may no longer be properly connected. The loopback predetermined period of time, like the first and second periods of time, may be any period of time, such as, for example, thirty seconds, a minute, two minutes, or any other amount of time that is sufficient for multiple cycles of loopback signals to have been sent from pin 212 to pin 214 and back to pin 210 and to adequately determine that the display screen 106 is no longer properly connected or functioning and servicing is needed.

In one or more embodiments, when the processor 104 makes the determination that the loopback signal has not been received by pin 214 during the loopback predetermined period of time, then processor 104 records this in log 112 and/or may notify an external device 122, such as that used by a technician, that the display screen 106 is no longer properly connected to processor 104. If, instead, when the loopback signal is present, but the periodic signal is still not present, in one or more embodiments, the processor 104 begins performing one or more operations to restart the display screen 106 as described in more detail below with regards to FIGS. 3 and 4. In one or more embodiments, the processor 104 may reset the display screen by sending a reset signal to processing component 204. In one or more embodiments, a reset signal is sent from pins 216 to pins 218, which causes at least the processing component 204 to reset. The processing component 202 then waits a second predetermined amount of time and determines if the periodic signal on pin 208 has returned. If the periodic signal has not returned, then other actions, as described in more detail below, are taken, and/or a technician or external device 122 is notified that repairs are needed.

### Example method for operating the thermostat

FIG. 3 is a flowchart illustrating method 300 of operating the thermostat 102 of FIG. 1 to determine if a reset action should be performed in accordance with one or more embodiments. Method 300 may be performed by the HVAC system 100 and thermostat 102, as shown and described above, with regard to FIGS. 1 and 2 or may be performed by any HVAC system, e.g., 100, and thermostat, e.g., 102, or another heating system and components. The method of FIG. 3 is not limited to the HVAC system, e.g., 100 described above with regards to FIG. 1 and 2. It may take any form that includes a thermostat 102 that includes a display screen 106.

Method 300 begins by monitoring a tear enable pin 208 of processing component 202 associated with processor 104 for a periodic signal in operation 305. In one or more embodiments, the periodic signal is sent from pin 206 at a predetermined rate, such as once a second, every five seconds, or at another frequency. The frequency of the periodic signal may be more or less than those just described, and the disclosure is not limited to a specific frequency. Alternatively, the periodic signal may be a constant signal or may be transmitted from a different pin than pin 206 and/or received at a different pin than pin 208.

Once the processor 104 begins monitoring the tear enable pin 208 for the periodic signal in operation 305; it determines in operation 310 if the first predetermined period of time has passed. The first predetermined period of time may be any amount of time, for example, thirty seconds, a minute, or another time period that is greater than the frequency of the periodic signal and sufficient to indicate that the display screen 106 is no longer functioning but not so short that the processor 104 is too frequently performing reset actions even when the display screen 106 is functioning properly. If the first predetermined period of time has not passed in operation 310, the processor 104 performs operation 315. In operation 315, the processor 104 records in log 112 that the periodic signal has been received and continues to monitor the tear enable pin 208 for the periodic signal. Operations 305-315 are repeated by the processor 104 until the first predetermined period of time has passed.

Once the first predetermined period of time has passed, method 300 then proceeds to operation 320. In operation 320, the processor 104 determines if the periodic signal has been received at pin 208. If the periodic signal has been received, the processor 104 performs operation 315 and repeats operations 305-315 for another first period of time, continuously monitoring the status of the display screen 106. However, when processor 104 determines in operation 320 that the periodic signal has not been received, it then records in log 112 that the signal has not been received and continues monitoring in operation 335 and determines if a second predetermined period of time has passed in operation 340. The second period of time is sufficient to indicate that active actions are needed to restore the operation of the display screen 106. In one or more embodiments, both the first predetermined amount of time and a second predetermined amount of time may be the same amount of time. Alternatively, they may be different amounts of time, and both may be several seconds, thirty seconds, a minute, multiple minutes, or any other amount of time without departing from the disclosure.

If the processor 104 determines the second predetermined period of time has not passed, then method 300 returns to operation 335, and the processor 104 continues monitoring until the second predetermined period of time has passed. Once the processor 104 determines in operation 340 that the second period of time has passed, then the processor in operation 345 determines if the periodic signal has been received. If it has, then the method returns to operation 315, and operations 305-345 repeat. If, however, the periodic signal is not received during the first predetermined period of time as determined in operation 320 and has not been received during the second period of time in operation 345, then the processor performs a reset action in operation 350. The reset action may be any action to reset the display screen 106. In one or more embodiments, the reset action is performed as described in method 400 of FIG. 4 described below. The reset action performed by the processor 104 in operation 350 is not limited to the reset action described in method 400.

Once the reset action is performed by the processor 104 in operation 350, the processor 104 then determines if the reset action was successful in operation 355. The processor may determine the reset action was successful in operation 355 by receiving the periodic signal again or a different signal that indicates that the display screen 106 has been successfully reset. In one or more embodiments the processor 104 may determine if the reset action was successful by reviewing the logs 112 for the reset action and determining if the logs indicate that the periodic signal has been received, or that the reset action was not successful as will be described in more detail below with regards to the method 400 of FIG. 4. If processor 104 determines in operation 355 that the reset action was successful, then method 300 returns to operation 315, and method 300 repeats operations 305-355 until the reset action is not successful.

If processor 104 determines that the reset action is not successful in operation 355, the processor 104 in an optional operation 360 may notify an external device 122 external device 122 or technician or another party that the thermostat needs repair. The processor 104 may also send the logs to the external device 122 in optional operation 360. This allows a technician or other appropriate party to be able to easily diagnose and decide at least what initial actions need to be made to repair thermostat 102 or HVAC system 100. Once the notification is sent in operation 360, method 300 may end.

Modifications, additions, or omissions may be made to method 300, as depicted in FIG. 3. Method 300 may include more, fewer, or other operations. For example, operations may be performed in parallel or in any suitable order. While discussed as an HVAC system 100, thermostat 102, or components thereof performing the operations, any suitable component of HVAC system 100 and/or thermostat 102 may perform one or more of the operations of method 300. While discussed as continuing to perform operation 305-355 until a reset action is not successful, in one or more embodiments, method 300 may end after either operation 320 or 345 when it is determined that the periodic signal has been received.

### Example method for performing a reset action

FIG. 4 is a flowchart illustrating an exemplary method 400 for performing a reset action of the display screen 106 of the thermostat 102 of FIGS. 1 and 2. Method 400 may be performed by the HVAC system 100 and/or thermostat 102 shown and described above with regards to FIG. 1 and FIG. 2 or may be performed by any HVAC system, e.g., 100, thermostat, e.g., 102, or other heating system and thermostat. The method 400 may be performed during operation 350 of method 300 described above with regards to FIG. 3, or it may be performed with one or more other methods, e.g., 300, that determine if a reset action should be performed in accordance with one or more embodiments.

Method 400 begins by determining if the loopback signal is present in operation 405. The loopback signal in one or more embodiments is sent periodically from pin 212 of processing component 204 to pin 214 of processing component 202. The signal is then sent back to pin 210 of processing component 204. This loopback signal when received, indicates that the display screen 106 is properly connected to the thermostat 102 and/or processor 104. The loopback signal may be a continuous signal, or it may be a signal that is sent periodically.

In one or more embodiments, the processor 104 determines in operation 410 if the loopback signal is present. If the loopback signal is not present, method 400 proceeds to operation 415, wherein the processor 104 records in the log 112 that the loopback signal is not present, and method 400 ends and/or returns to operation 355 of method 300, shown in FIG. 3 and described above. Alternatively, if the loopback signal is present in operation 410, method 400 proceeds to operation 420.

In operation 420, a reset display signal is sent to the display screen 106 from the processor 104. In one or more embodiments, the signal is sent from pin 216 of processing component 202 to pin 218 of processing component 204. However, the reset signal may take any form and be sent from any pin or connector 118A-118N or processor 104 without departing from the disclosure. This reset signal causes the display screen 106 to perform a reset. The reset may be any process that the display screen 106 is designed to perform and may include one or more operations specific to the specific type of display. This may include a reboot of processing components, e.g., 204 and/or the power supply that powers the display screen 106. The reset signal may cause the display screen 106 to perform any operation to reset, and the disclosure is not limited to those just discussed.

Returning to method 400, once the reset display signal is sent in operation 420, the processor 104 waits a third predetermined period of time to determine if the periodic signal has resumed in operation 425. In one or more embodiments, the third predetermined period of time is the same as the first period of time. However, the third predetermined period of time may be any length of time determined to allow the display screen 106 to restart and resume sending the periodic signal and may be any time such as, but not limited to thirty seconds, a minute, five minutes, or another length of time specific to the particular display screen 106 or the preference of a manufacturer, technician, user, or other concerned party.

In operation 430, the processor 104 determines if the periodic signal has been received. If the periodic signal has been received in operation 430, method 400 proceeds to operation 470, where an indication is stored in log 112 that the periodic signal has been received and the steps that were performed to restore the display screen 106. If, however, in operation 430, the processor 104 determines that the periodic signal has not been received, the processor 104 then performs an optional kernel panic and reboots the display screen in operation 435. In one or more embodiments, when performing the kernel panic, the processor 104 causes the processing component 202 and other components of the processor 104 to stop and then reset, as well as the display screen 106. The kernel panic and reboot of operation 435 may take any form and may comprise any operations that are appropriate for the specific processor 104 and display screen 106, and the disclosure is not limited to any specific kernel panic and reboot operations.

Once the kernel panic and reboot are performed in operation 435, the processor 104 waits a fourth predetermined period of time to determine if the periodic signal has resumed. The fourth predetermined period of time, like the third predetermined period of time, may be based on the amount of time it takes to perform the reboot of the display screen 106 and for it to resume sending the periodic signal. The fourth predetermined period of time may be any length of time and may be the same or different from the third predetermined period of time without departing from the disclosure.

Once the processor 104 waits for the fourth predetermined period of time in operation 440, it determines if the periodic signal has been received in operation 445. If the periodic signal has been received, method 400 proceeds to operation 470, where an indication is stored in log 112 that the periodic signal has been received and the steps that were performed to restore the display screen 106. If, however, in operation 445, the processor 104 determines that the periodic signal has not been received in the processor 104, then it causes the power sequencer to reset both the processor 104 and display screen 106 in operation 450. While method 400 shows the processor 104 performing operations 435-445 prior to performing operation 450, in one or more embodiments, operation 435 may be excluded, and method 400 may proceed from operation 430 to operation 450.

Turning to operation 450, the processor 104 instructs the power sequencer 108 to reset the power to both the processor 104 and display screen 106. In one or more embodiments, the power sequencer 108 may reset some or all the components of the thermostat 102 and/or the HVAC system 100. Once the processor 104 instructs the power sequencer 108 to reset both the processor 104 and display screen 106 in operation 450, the method proceeds to operation 455, where the processor 104 waits a fifth predetermined period of time. The fifth predetermined period of time, like the third and fourth predetermined periods of time, may be based on the amount of time it takes to reboot both the processor 104 and display screen 106 and for it to resume sending the periodic signal. The fifth predetermined period of time may be any length of time and may be the same or different than the third or fourth predetermined period of time without departing from the disclosure.

Once the processor 104 waits for the fifth predetermined period of time, method 400 proceeds to operation 460. In operation 460, the processor 104 determines if the periodic signal has been received. If the periodic signal has not been received, method 400 proceeds to operation 465, where processor 104 indicates in log 112 that the reset action was not successful, along with the steps that were taken to restore the display screen 106. Method 400 may then end and/or return to operation 355 of method 300 of FIG. 3. Alternatively, if the periodic signal has been received, method 400 proceeds to operation 470, where the processor 104 records in the log that the periodic signal has been received and the various steps used to restore the display screen 106. By recording in the log 112 the steps that were taken, a technician in the future may be able to determine ongoing problems with the processor 104 and/or display screen 106. While operation 470 is shown to be performed when the periodic signal has been received in operations 430, 445, and 460, in one or more embodiments operation 470 may instead be performed as part of sending the reset display signal operation 420, perform the kernel panic in operation 435, and instructing the power sequencer to reset both the processor and display screen in operation 450.

Once the processor 104 indicates in the log 112 that the reset action was successful in operation 470 or indicates in the log 112 that the reset action was not successful in operations 415 and 465, method 400 returns to operation 355 of FIG. 3. Alternatively, or in addition after operations 415, 470, and 465 the method 400 may end. Modifications, additions, or omissions may be made to method 400 as depicted in FIG. 4. Method 400 may include more, fewer, or other operations. For example, operations may be performed in parallel or in any suitable order. While discussed as being performed by the processor 104 situated in the thermostat 102, the method may be performed by any controller, processor, or other part of the HVAC system 100 and/or thermostat 102. Any suitable component of HVAC system 100 may perform one or more operations of method 400.

Although this disclosure has been described in terms of certain embodiments, alterations, and permutations, embodiments will be apparent to those skilled in the art. Accordingly, the above description of the embodiments does not constrain this disclosure. Other changes, substitutions, and alterations are possible without departing from the spirit and scope of this disclosure.

While several embodiments have been provided in the present disclosure, it should be understood that the disclosed systems and methods might be embodied in many other specific forms without departing from the spirit or scope of the present disclosure. The present examples are to be considered illustrative and not restrictive, and the intention is not to be limited to the details given herein. For example, the various elements or components may be combined or integrated with another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A thermostat comprising:
a display screen configured to display information received from a processor, wherein the information is associated with operating a heating or cooling system; and
a processor operably coupled to the display screen, the processor configured to:
monitor a periodic signal received from the display screen, wherein the periodic signal is received on a connector of the processor associated with a tear enable signal;
determine if the periodic signal has been received during a first predetermined period of time; and
perform a reset action to reset the display screen when the periodic signal is not received in the first predetermined period of time.

2. The thermostat of claim 1, wherein the processor includes at least a second connector that receives a loopback signal from the display screen, which is used to determine if the display screen is operatively connected to the processor and when the loopback signal indicates that the display screen is not operatively connected to the processor, the processor sends an electronic signal to an external device indicating that the thermostat needs repair.

3. The thermostat of claim 1, wherein the reset action comprises sending a reset display signal to the display screen.

4. The thermostat of claim 3, wherein after sending the reset display signal, the processor determines if the periodic signal has been received during a second predetermined period of time, and when the periodic signal has not been received during the second predetermined period of time, an action to reset both the processor and the display screen is performed.

5. The thermostat of claim 4, further comprising a power sequencer that provides power to the processor and the display screen, and wherein the action to reset both the processor and the display screen comprises the processor instructing the power sequencer to reset the power to both the processor and the display screen.

6. The thermostat of claim 3, wherein after sending the reset display signal, the processor determines if the periodic signal has been received during a second predetermined period of time and when the periodic signal has not been received during the second predetermined period of time, the processor performs a kernel panic and automatically reboots both the processor and the display screen.

7. The thermostat of claim 1, wherein the display screen is a liquid crystal display (LCD) that, during normal operation, does not use the tear enable signal.

8. The thermostat of claim 1, wherein the processor is further configured to:
determine if the reset action is successful by monitoring the periodic signal for a third period of time; and
send a notification to an external device that the thermostat needs repair when the periodic signal is not received during the third period of time.

9. A method, comprising:
monitoring by a processor, a periodic signal received from a display screen that is operably coupled to the processor and configured to display information associated with operating a heating or cooling system;
determining by the processor, if the periodic signal has been received during a first predetermined period of time; and
performing by the processor, a reset action to reset the display screen when the periodic signal is not received in the first predetermined period of time,
wherein the periodic signal is received on a connector of the processor associated with a tear enable signal.

10. The method of claim 9, wherein the reset action comprises sending a reset display signal to the display screen.

11. The method of claim 10, wherein after sending the reset display signal, the processor determines if the periodic signal has been received during a second predetermined period of time and when the periodic signal has not been received during the second predetermined period of time an action to reset both the processor and the display screen is performed.

12. The method of claim 10, wherein after sending the reset display signal, the processor determines if the periodic signal has been received during a second predetermined period of time and when the periodic signal has not been received during the second predetermined period of time, the processor performs a kernel panic and automatically reboots both the processor and the display screen.

13. The method of claim 9, wherein the display screen is a liquid crystal display (LCD) that, during normal operation, does not use the tear enable signal.

14. The method of claim 9, further comprising:
determining by the processor, if the reset action is successful by monitoring the periodic signal for a third period of time; and
sending by the processor a notification to an external device that the reset action was not successful when the periodic signal is not received during the third period of time.

15. A non-transitory computer-readable medium storing instructions that, when executed by a processor, cause the processor to:
monitoring by the processor, a periodic signal received from a display screen that is operably coupled to the processor and configured to display information associated with operating a heating or cooling system;
determining by the processor, if the periodic signal has been received during a first predetermined period of time; and
performing by the processor, a reset action to reset the display screen when the periodic signal is not received in the first predetermined period of time,
wherein the periodic signal is received on a connector of the processor associated with a tear enable signal.

16. The non-transitory computer-readable medium of claim 15, wherein the reset action comprises sending a reset display signal to the display screen.

17. The non-transitory computer-readable medium of claim 16, wherein after sending the reset display signal, the processor determines if the periodic signal has been received during a second predetermined period of time and when the periodic signal has not been received during the second predetermined period of time an action to reset both the processor and the display screen is performed.

18. The non-transitory computer-readable medium of claim 16, wherein after sending the reset display signal, the processor determines if the periodic signal has been received during a second predetermined period of time and when the periodic signal has not been received during the second predetermined period of time, the processor performs a kernel panic and automatically reboots both the processor and the display screen.

19. The non-transitory computer-readable medium of claim 15, wherein the display screen is a liquid crystal display (LCD) that during normal operation does not use the tear enable signal.

20. The non-transitory computer-readable medium of claim 15, wherein the instructions further cause the processor to:
determine if the reset action is successful by monitoring the periodic signal for a third period of time; and
send a notification to an external device that the reset action was not successful when the periodic signal is not received during the third period of time.
